(19) United States
(12) Patent Application Publication
(10) Pub. No.: US 2009/0282064 A1
(43) Pub. Date: Nov. 12, 2009

(54) ON THE FLY COMPRESSION AND STORAGE DEVICE, SYSTEM AND METHOD

(76) Inventors: VEERAMANIKANDAN RAJU, Bangalore (IN); Keshava Munegowda, Bangalore (IN); Rohit Joshi, Varanasi (IN)

Correspondence Address: Wade James Brady III;Texas Instruments Incorporated, P.O. Box 655474, M/S 3999, Dallas, TX, 75265, US

(21) Appl. No.: 12/116,204

(22) Filed: May 7, 2008

(51) Int. Cl. G06F 17/30

(52) U.S. Cl. 707/101; 707/E17.009

(57) ABSTRACT

Systems and methods for on the fly compression and storage device for compressing/decompressing data are disclosed. In one embodiment, an on the fly compression and storage system includes a file system for forwarding data for storing, one or more compression drivers, with one of the compression drivers invoked for compressing the data forwarded by the file system into compressed data, and a storage device for storing the compressed data. The compressing of the data and the storing of the compressed data are seamlessly performed. A status of the storage device is dynamically updated to the file system based on the compressing of the data.

### FIELD OF TECHNOLOGY

Embodiments of the present invention relate to the field of electronics. More particularly, embodiments of the present invention relate to compression/decompression technology.

### BACKGROUND

Data compression is the process of encoding information using fewer bits (or other information-bearing units) than an unencoded representation would use through use of specific encoding schemes. Compression is useful because it helps reduce the consumption of expensive resources, such as hard disk space or transmission bandwidth. One technique of data compression is by using a data compression program to reduce size of a file which is already stored in a physical drive. Another data compression technique involves data compression at the file system level where the data compression takes place in the background based on the antiquity of the compressed file.

Such existing data compression techniques may apply same data compression algorithm to different types of data present in the file system. As a result, for some data types, the data compression algorithm applied across the board may not be effective in saving the storage space. For example, a data compression technique which may work well with text data may not be so effective in compressing video data. In addition, in spite of the storage space being saved, it may be time consuming to go through the steps of writing and compressing the data and decompressing and reading the data, since the steps are taking place sequentially rather than concurrently.

### SUMMARY

Systems and methods for on the fly compression and storage device are disclosed. In one aspect, an on the fly compression and storage system includes a file system for forwarding data for storing, one or more compression drivers, with one of the compression drivers invoked for compressing the data forwarded by the file system into compressed data, and a storage device for storing the compressed data. Further, each one of the compression drivers includes an algorithm for decompressing the compressed data into the data if the data is accessed by the file system for reading. In addition, the compression drivers are pluggable. The compressing of the data and the storing of the compressed data are seamlessly performed.

Furthermore, a particular one of the compression drivers is automatically invoked based on a type of the data forwarded by the file system. The type of the data is associated with an application program accessing the data using the file system. The type of the data includes text data, image data, audio data, or video data. The system further includes a flash block management module for managing the flash memory.

In another aspect, an on the fly compression and storage device includes a compression module for compressing data forwarded by a file system into compressed data and a storage device for storing the compressed data. The compression module includes multiple compression algorithms with each compression algorithm invoked for the compressing of a particular type of the data. Furthermore, the file system resides in a host device coupled to the compression module and the storage device. In addition, the storage device includes a flash memory. The compression module further includes an algorithm for decompressing the compressed data into the data if the data is accessed by the file system for reading.

In yet another aspect, an on the fly compression/decompression method includes determining a compression algorithm suitable for data forwarded by a file system for storing in a storage device, compressing the data into compressed data using the compression algorithm, and automatically forwarding the compressed data to the storage device. The compressing of the data and the storing of the compressed data are seamlessly performed. The method further includes decompressing the compressed data into the data if the data is accessed by the file system for reading.

Furthermore, a status of the storage device is dynamically updated to the file system based on the compressing of the data. The status of the storage device includes a total device size, a used device space or an available device space. The status of the storage device is forwarded to the file system in response to a request by the file system. In addition, the status of the storage device is dynamically updated to the file system based on the compressing of the data.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a block diagram of an exemplary on the fly compression and storage system, according to one embodiment.

FIG. 2 is a block diagram of an exemplary on the fly compression and storage system with multiple compression drivers, according to one embodiment.

FIG. 3 is a block diagram of an exemplary on the fly compression and storage device, according to one embodiment.

FIG. 4 is a process flow chart of an exemplary on the fly compression and storage method, according to one embodiment.

Other features of the present embodiments will be apparent from the accompanying drawings and from the detailed description that follows.

### DETAILED DESCRIPTION

A system and method for on the fly compression and storage device is disclosed. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

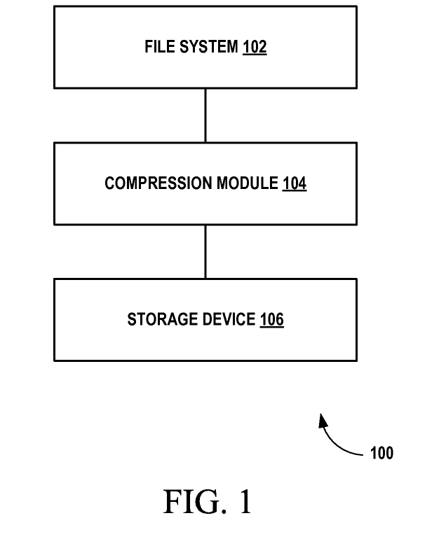

FIG. 1 is a block diagram of an exemplary on the fly compression and storage system 100, according to one embodiment. Particularly, the on the fly compression and storage system 100 includes a file system 102, a compression module 104 and a storage device 106.

In one embodiment, the file system 102 forwards data for storing. In one example embodiment, the file system 102 forwards the data to the compression module 104. Further, the compression module 104 is configured to compress the data forwarded by the file system 102 into compressed data. Also, the compression module 104 includes an algorithm for decompressing the compressed data into the data if the data is accessed by the file system 102 for reading. In one exemplary implementation, the compression module 104 compresses the data written to the storage device 106 and decompresses the compressed data retrieved from the storage device 106 with unique plug-in capabilities.

It is appreciated that the on the fly compression and storage system 100 can grow the storage space without affecting its associated file system or user applications. It is also appreciated that the on the fly compression and storage system 100 can perform compression/decompression of meta-data as well as user data being stored, thus improving overall storage capacity of the storage device.

In addition, the storage device 106 coupled to the compression module 104 stores the compressed data. In one exemplary implementation, the compressing of the data and the storing of the compressed data are seamlessly (e.g., concurrently, one the fly, etc.) performed. Also, a status of the storage device 106 is dynamically updated to the file system 102 based on the compressing of the data.

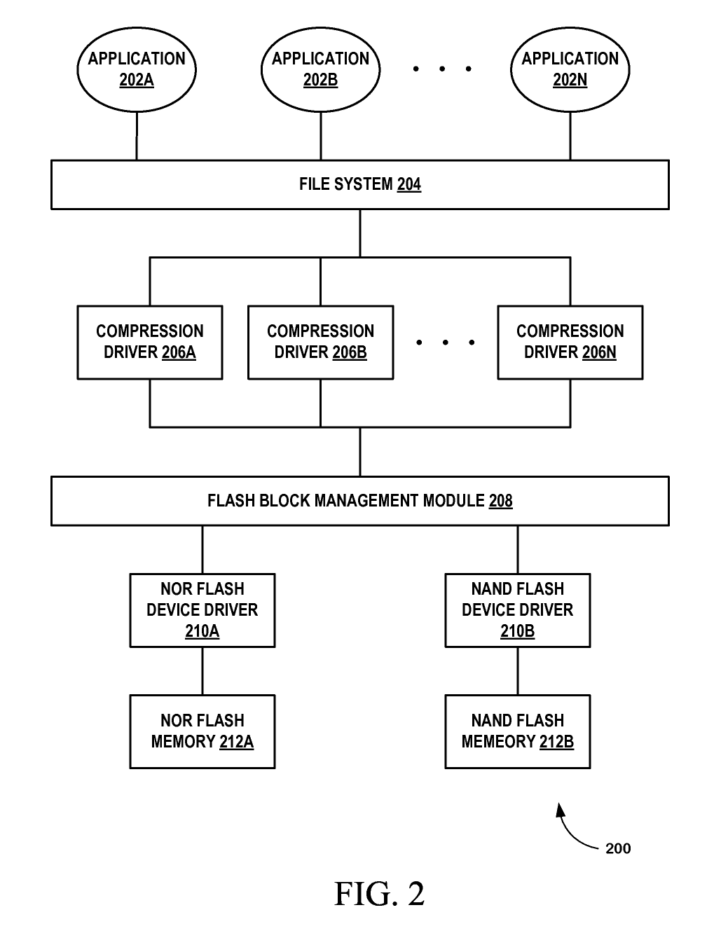

FIG. 2 is a block diagram of an exemplary on the fly compression and storage system 200 with multiple compression drivers 206A-N, according to one embodiment. As shown in FIG. 2, the on the fly compression and storage system 200 includes a file system 204 for forwarding data for storing. It is appreciated that the file system is an exemplary embodiment of the file system 102 of FIG. 1. Also, the on the fly compression and storage system 200 includes the multiple compression drivers 206A-

It is appreciated that a particular one of the compression drivers is automatically invoked based on a type of the data forwarded by the file system 204. In one example embodiment, the type of the data is associated with an application (e.g., the application 202A, 202B . . . 202N) accessing the data using the file system 204. For example, the type of the data includes text data, image data, audio data, or video data.

Further, the on the fly compression and storage system 200 includes a storage device for storing the compressed data. It is appreciated that the storage device is an exemplary embodiment of the storage device 106. In one embodiment, the storage device includes a flash memory (e.g., a NOR flash memory 212A, a NAND flash memory 212B, etc.).

As shown in FIG. 2, the on the fly compression and storage system 200 includes a flash block management module 208 coupled with the compression drivers 206A-N for managing the flash memory through flash device drivers (e.g., a NOR flash device driver 210A, a NAND flash device driver 210B, etc.). In one exemplary implementation, the compressing of the data and the storing of the compressed data are seamlessly performed. In addition, a status of the storage device 106 is dynamically updated to the file system 204 based on the compressing of the data. In one example embodiment, the status of the storage device 106 includes a total device size, a used device space, or an available device space.

It is appreciated that, each one of the multiple compression drivers 206A-N includes an algorithm for decompressing the compressed data into the data, if the data is accessed by the file system 204 for reading.

In accordance with one example embodiment, the compression drivers 206A-N are independent of the file system 204. Therefore, the user data and file system meta-data are compressed while writing data to media. In one example embodiment, each driver can invoke a unique or different compression algorithm based on a type of data. For example, a computer system can support multiple compression drivers (e.g., the compression driver 206A, 206 B, etc.), where the compression driver 206A can be used to store text data and the compression driver 206B can be used to store multimedia data such as image data, video data, or audio data. It is appreciated that the compression driver 206A through 206N can be implemented using software or hardware.

For example, consider “my documents” folder of MS Windows® having multiple folders such as “my images” folder, “my music” folder and/or “my video” folder. When an application is invoked to store music data, the file system 204 maps the music application to “my music” folder. Furthermore, a compression driver associated with a compression algorithm is plugged in and/or called for compressing the music data. Hence, the music application is compressed on-the-fly and stored in “my music” folder. In case, another application is invoked to store an image data, the file system 204 tries to store the image data in “my image” folder by mapping the image data to “my image” folder (i.e., a logical drive). It is appreciated that, each compression driver is associated with a different compression algorithm, based on the type of data forwarded by the file system 204.

In flash memory, a garbage collection or wear-leveling algorithm is often required. In one embodiment, the on the fly compression and storage system 200 reduces the number of block writes due to the on the fly data compression operation. Less frequent block writes translate to less number of dirty blocks, so space required for the garbage collection or wear-leveling algorithm can be reduced because of the reduction of dirty blocks. In addition, the reduction of dirty blocks reduces erase cycles per flash block and thus, improving longevity of the flash memory.

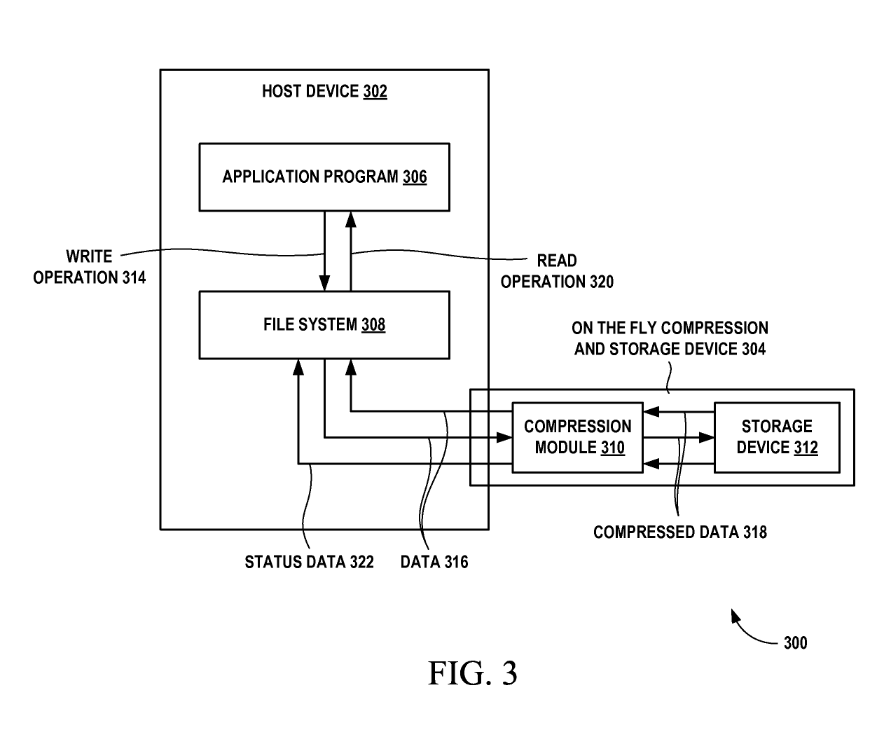

FIG. 3 is a block diagram 300 of an exemplary on the fly compression and storage device 304, according to one embodiment. The on the fly compression and storage device 304 includes a compression module 310 for compressing data 316 forwarded by a file system 308 into compressed data 318. In one embodiment, the compression module 310 includes multiple compression algorithms with each compression algorithm invoked for the compressing of a particular type of the data (e.g., the data 316). It is appreciated that the compression module 310 is an exemplary embodiment of the compression module 104 of FIG. 1. In one example embodiment, the type of the data is associated with an application program 306 accessing (e.g., write operation 314 or read operation 320) the data 316 using the file system 308.

The on the fly compression and storage device 304 also includes a storage device 312 for storing the compressed data 318. It is appreciated that the storage device is an exemplary embodiment of the storage device 106. In one embodiment, the compressing of the data 316 and the storing of the compressed data 318 are seamlessly performed. As shown in FIG. 3, the file system 308 resides in a host device 302 coupled to the compression module 310 and the storage device 312. Also, the storage device 312 includes a flash memory.

For example, consider a storage device (e.g. flash memory) having a physical storage space of 1 MB. So, by using the compression technology, the physical device can store more than 1 MB of data based on its compression ratio. In one embodiment, the compression ratio refers to ratio between number of compressed bytes (e.g., number of output bytes of compression algorithm) and the number of input bytes (e.g., inputted to the compression algorithm).

In one example implementation, the on the fly compression and storage device 304 with a physical storage space of 1 MB and a compression ratio of 1.5 initially shows 1.0 MB as its available storage space. If 200 KB data is stored in the device, 100 KB of the physical storage space is used up since the 200 KB data is compressed into 100 KB before it is written to the storage. Accordingly, at the end of the operation, the file system or the user sees that the total disk size is 1.1 MB, the used disk space is 0.20 MB and the available disk space is 0.90 MB.

In one embodiment, a status of the storage device 312 is dynamically updated to the file system 308 (e.g., through the status data 322) based on the compressing of the data 316. In one example embodiment, the status of the storage device 312 includes a total device size, a used device space or an available device space. Further, the status data 322 of the storage device 312 is forwarded to the file system 308 in response to a request by the file system 308. It is appreciated that the compression/decompression operation is transparent to the file system or user. The compression module 310 includes an algorithm for decompressing the compressed data 318 into the data 316 if the data 316 is accessed by the file system 308 for reading (i.e., to perform read operation 320).

The on the fly compression and storage device 304 concurrently compresses the data 316 written into the flash memory and decompresses the data 316 retrieved from the flash memory with unique plug-in capabilities. In one embodiment, on the fly refers to the nature of concurrently performing the compression of the data 316 (e.g.,

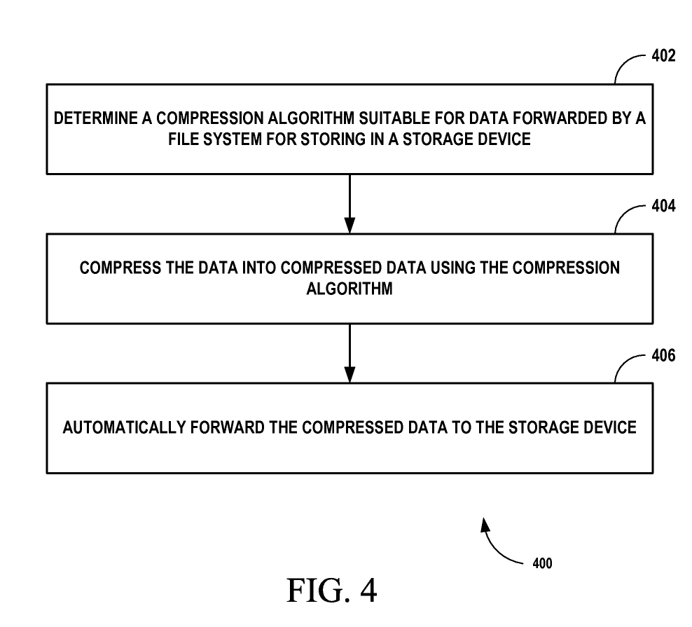

FIG. 4 is a process flow chart 400 of an exemplary on the fly compression and storage method, according to one embodiment. In step 402, a compression algorithm suitable for data forwarded by a file system for storing in a storage device is determined. In step 404, the data is compressed into compressed data using the compression algorithm. In step 406, the compressed data is automatically forwarded to the storage device. In one exemplary implementation, a status of the storage device is dynamically updated to the file system based on the compressing of the data. Further, the status of the storage device is forwarded to the file system in response to a request by the file system. It is appreciated that the compressed data is decompressed into the data if the data is accessed by the file system for reading.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated circuitry (ASIC)).

What is claimed is:

1. An on the fly compression and storage system, comprising:
a file system for forwarding data for storing;
at least one compression driver, with one of the at least one compression driver invoked for compressing the data forwarded by the file system into compressed data; and
a storage device for storing the compressed data,
wherein the compressing of the data and the storing of the compressed data are seamlessly performed; and
wherein a status of the storage device is dynamically updated to the file system based on the compressing of the data.

2. The system of claim 1, wherein a particular one of the at least one compression driver is automatically invoked based on a type of the data forwarded by the file system.

3. The system of claim 2, wherein the type of the data is associated with an application program accessing the data using the file system.

4. The system of claim 2, wherein the type of the data comprises text data, image data, audio data, or video data.

5. The system of claim 1, wherein the status of the storage device comprises a total device size, a used device space, or an available device space.

6. The system of claim 1, wherein the storage device comprises a flash memory.

7. The system of claim 6, further comprising a flash block management module for managing the flash memory.

8. The system of claim 1, wherein each one of the at least one compression driver comprises an algorithm for decompressing the compressed data into the data, if the data is accessed by the file system for reading.

9. The system of claim 1, wherein the at least one compression driver is pluggable.

10. An on the fly compression and storage device, comprising:
a compression module for compressing data forwarded by a file system into compressed data; and
a storage device for storing the compressed data,
wherein the compressing the data and the storing the compressed data are seamlessly performed; and
wherein a status of the storage device is dynamically updated to the file system based on the compressing of the data.

11. The device of claim 10, wherein the compression module comprises a plurality of compression algorithms with each compression algorithm invoked for the compressing of a particular type of the data.

12. The device of claim 10, wherein the file system resides in a host device coupled to the compression module and the storage device.

13. The device of claim 10, wherein the storage device comprises a flash memory.

14. The device of claim 10, wherein the status of the storage device comprises a total device size, a used device space or an available device space.

15. The device of claim 10, wherein the status of the storage device is forwarded to the file system in response to a request by the file system.

16. The device of claim 10, wherein the compression module comprises an algorithm for decompressing the compressed data into the data if the data is accessed by the file system for reading.

17. An on the fly compression/decompression method, comprising:
determining a compression algorithm suitable for data forwarded by a file system for storing in a storage device;
compressing the data into compressed data using the compression algorithm and;
automatically forwarding the compressed data to the storage device.

18. The method of claim 17, wherein a status of the storage device is dynamically updated to the file system based on the compressing of the data.

19. The method of claim 18, wherein the status of the storage device is forwarded to the file system in response to a request by the file system.

20. The method of claim 17, further comprising decompressing the compressed data into the data if the data is accessed by the file system for reading.
